(19) United States
(12) Patent Application Publication
(10) Pub. No.: US 2026/0074634 A1
(43) Pub. Date: Mar. 12, 2026

(54) SYSTEMS AND METHODS FOR CONTROLLING A MOTOR WITH DYNAMICALLY PARAMETERIZED TRAJECTORY ESTIMATION

(71) Applicant: Mitsubishi Electric Research Laboratories, Inc., Cambridge, MA (US)

(72) Inventors: Yebin Wang, Cambridge, MA (US); Zehui Lu, West Lafayette, IN (US); Tianpeng Zhang, Boston, MA (US); Abraham Goldsmith, Boston, MA (US)

(73) Assignee: Mitsubishi Electric Research Laboratories, Inc., Cambridge, MA (US)

(21) Appl. No.: 18/830,871

(22) Filed: Sep. 11, 2024

(51) Int. Cl. H02P 21/00; H02P 21/20

(52) U.S. Cl. CPC H02P 21/0017; H02P 21/20; H02P 2205/05; H02P 2205/07

(57) ABSTRACT

A controller for controlling a motor comprises a processor and a memory having instructions stored thereon that, when executed by the processor, cause the controller to collect a feedback signal indicative of the current state of an operation of the motor and determine current constraints on parameters of the operation of the motor using model of dynamics of the motor connecting the current state of the motor with the current constraints on the operation. The processor is further configured to determine a control trajectory of the operation of the motor based on the current constraints on parameters of the operation of the motor using a parametrized estimation agnostic to the dynamics of the motor and control the operation of the motor according to the control trajectory.

### TECHNICAL FIELD

The present disclosure relates generally to motion control systems and more particularly to systems and methods for optimizing the performance of motors in such systems.

### BACKGROUND

Controlling a precision motion system requires a real-time control strategy for its associated motor drive. In precision motion systems, such as those based on motor drives, controlling the movement of components of the system with high accuracy and speed is crucial. One approach in this regard employs a control strategy that dictates how the machine's motor should operate. However, developing an effective control strategy presents several challenges, especially when balancing the need for precision with the constraints of limited computational resources.

Conventional control strategies for such systems are mainly of two types: optimization-based approaches and parameterized trajectory control strategies. The optimization-based approach generates optimal motion trajectories that ensure the motor operates within its physical limits. However, they are computationally intensive and time-consuming, making them difficult to implement on machines with limited computational power, especially in real-time applications. The parameterized trajectory control strategies on the other hand are designed to be computationally efficient, generating motion trajectories quickly using predefined parameters. However, they do not fully account for the motor's dynamic constraints, which can result in trajectories that are not physically feasible. To prevent unsafe or infeasible operations, conservative safety margins are applied, which reduce the system's overall speed and productivity.

Accordingly, there is a need for control solutions for precision motion systems that are fast, efficient and can produce feasible trajectories.

### SUMMARY

Some embodiments are directed towards solutions for faster and more efficient positioning of objects by solving open-loop optimal control problems and reshaping baseline trajectories to fully utilize a motor's capabilities. It is an object of several embodiments to provide a motion control system which can complete a positioning task as quickly as possible.

A motion control system includes one or a combination of a motion planner, (motion) tracking controller, an amplifier, and a motor. The motion planner generates a reference trajectory of the motion of the motor. The tracking controller determines a control signal to ensure the motor follows the reference trajectory. In some embodiments, the control signal may be a torque command. The amplifier converts the control signal to voltage supplied to motor, and the motor drives the load with electromagnetic torque. Some example embodiments are based on the realization that the motion planner, without accurate information about the underlying motor information, might generate a reference trajectory that is not feasible for the motor to follow (dynamically infeasible). In order to prevent occurrence of the dynamical infeasibility, the motion planner tends to introduce an unnecessarily large safety margin during trajectory generation and produces a conservative reference trajectory which does not fully utilize the torque capacity of the motor—something which is a compromise on the productivity of the motion control system.

Some example embodiments provide a fast motion control system and methods to generate a (less conservative) fast dynamically feasible trajectory of the motion of the motor of the motion control system to reduce the conservatism in the baseline method wherein, the torque constraint is not accurately known and thus a large safety margin is introduced to ensure the dynamical feasibility of the generated trajectory.

It is a further object of the invention to provide a method for generating dynamically feasible trajectory of a motion of a motor of the motion control system, by considering various constraints of the motion control system including velocity, acceleration, current, torque, and voltage constraints.

Some embodiments are based on a realization of a hybrid approach for trajectory estimation that uses the dynamics of the motor to generate constraints on the operation of the motor and uses these constraints to generate the trajectory using a parametrized estimation agnostic to the dynamics of the motor. Further, using the generated constraints results in a more accurate parameterized trajectory than using the constraints predetermined in advance, because the constraints change over time. In effect, the embodiments provide a faster and more accurate generation of the reference trajectory via dynamically parameterized trajectory generation.

Accordingly, one embodiment discloses a method for generating a control signal for controlling an operation of a motion control system suitable for positioning a load. The method includes determining parameters of a dynamic model of the motor, constructing torque bounds of the motor; determining a trajectory of the control signal based on the constructed torque bounds; and generating the control signal based on the trajectory and a current state of the system, wherein the steps of the method are performed by a processor.

It is a further object of the invention to provide a method such that the torque bounds (constraints) can be constructed based the dynamic model of motor, where the torque constraints are represented as a lower bound and upper bound functions, wherein both functions are dependent on motor speed. The torque constraint modeling module builds an analytical mapping from the motor's dynamic model parameters to the maximum and minimum torque given the physical characteristics of the motor. The maximum and minimum motor torques are affected by the motor speed and voltage supplied to the motor. Thus, with the motor speed changing, the maximum and minimum motor torque can be different than the empirical value commonly used in the literature. This module can provide realistic information on the motor torque capacity, enabling the generation of dynamically feasible reference trajectories by explicitly taking motor torque capacity information into account.

It is a further object of the invention to provide a method such that values of parameters of the dynamic model of the motor can be estimated based on online measurement of motor operation data. Some embodiments of the invention are based on a realization that given measurements of motor currents and speed, the inductance and permanent magnet flux, a portion of parameters of the dynamic model of the motor, can be estimated by a dynamic parameter estimator. The dynamic parameter estimator estimates the motor parameters while the motor is running with conservative trajectory. The dynamic parameter estimator takes the motor current, voltage, and rotational speed as inputs, updates the estimated parameters by decreasing the error between the predicted currents and the measured currents. Thus, the parameter estimator module estimates the motor's major parameters while the motor is running, which enables the motor constraint modeling module.

In some embodiments, a fast trajectory can be generated by solving open-loop optimal control problem with the constructed torque constraints, velocity constraints, and boundary conditions wherein boundary conditions represent the initial and final position of the motion control system.

In some embodiments, a fast trajectory is determined by a motion reshaper which reshapes a baseline trajectory (output of conventional motion planner) by combining the learned torque bounds with a reference governor, wherein the baseline trajectory is generated by the conventional motion planner based on the rough knowledge of velocity, acceleration and torque constraints, and thus might be dynamically infeasible when the safety margin is small. The motion reshaper takes in the conventional trajectory produced by existing motion planner and returns the closest acceleration to the original one, where the motor torque constraint is explicitly addressed by the motion reshaper. Then the original desired acceleration is reshaped such that the motor toque constraints are satisfied.

Towards these ends, it is an objective of some example embodiments to provide systems, methods and computer program products for controlling a motor.

Accordingly, some example embodiments provide a controller for controlling a motor. The controller comprises a memory storing instructions and a processor configured to execute the instructions to control the motor. In this regard, the controller collects a feedback signal indicative of the current state of an operation of the motor. The controller determines current constraints on parameters of the operation of the motor using dynamics of the motor connecting the current state of the motor with the current constraints on the operation. The controller also determines a reference trajectory of the operation of the motor given the current constraints on parameters of the operation of the motor using a parametrized estimation agnostic to the dynamics of the motor. The controller controls the operation of the motor according to the determined reference trajectory.

In yet another example embodiment, a computer-implemented method for controlling a motor is provided. The method comprises collecting a feedback signal indicative of the current state of an operation of the motor and determining current constraints on parameters of the operation of the motor using dynamics of the motor connecting the current state of the motor with the current constraints on the operation. The method also comprises determining a reference trajectory of the operation of the motor given the current constraints on parameters of the operation of the motor using a parametrized estimation agnostic to the dynamics of the motor and controlling the operation of the motor according to the determined reference trajectory.

In yet some other example embodiments, a non-transitory computer readable medium having stored thereon computer executable instructions for performing a method for controlling a motor is provided. The method comprises collecting a feedback signal indicative of the current state of an operation of the motor and determining current constraints on parameters of the operation of the motor using dynamics of the motor connecting the current state of the motor with the current constraints on the operation. The method also comprises determining a reference trajectory of the operation of the motor given the current constraints on parameters of the operation of the motor using a parametrized estimation agnostic to the dynamics of the motor and controlling the operation of the motor according to the determined reference trajectory.

### BRIEF DESCRIPTION OF THE DRAWINGS

The presently disclosed embodiments will be further explained with reference to the following drawings. The drawings shown are not necessarily to scale, with emphasis instead generally being placed upon illustrating the principles of the presently disclosed embodiments.

FIG. 1A illustrates a flowchart of a method for controlling the operation of a motor, according to some embodiments;

FIG. 1B illustrates a block diagram of a motion control system, according to some embodiments;

FIG. 1C illustrates the components of a driver of the motor, according to some embodiments;

FIGS. 1D and 1E respectively illustrate the position profile and the velocity profile of the motor's load over time, according to some embodiments;

FIG. 2A illustrates a block diagram of the components of a fast motion control system, according to some embodiments.

FIGS. 2B and 2C are diagrams of the components of a motion planner, according to some embodiments;

FIG. 3A-3B are the diagrams of an estimator of parameters of a motor dynamic model, according to some embodiments;

FIG. 4 illustrates a framework for constructing torque capacity constraints based on the operation conditions and estimated motor model parameters, according to some embodiments;

FIGS. 5A and 5B illustrate block diagrams for shaping parameterized reference trajectory according to the constructed torque capacity constraints, according to some embodiments;

FIGS. 6A and 6B illustrate methods for generating a reshaped acceleration and velocity, according to some embodiments;

FIGS. 6C and 6D illustrate the block diagrams of methods for generating a control trajectory, according to some embodiments;

FIG. 7 shows a method for generating motor velocity, according to some embodiments; and

FIG. 8 illustrates some components of a system for controlling a motor, according to some embodiments.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

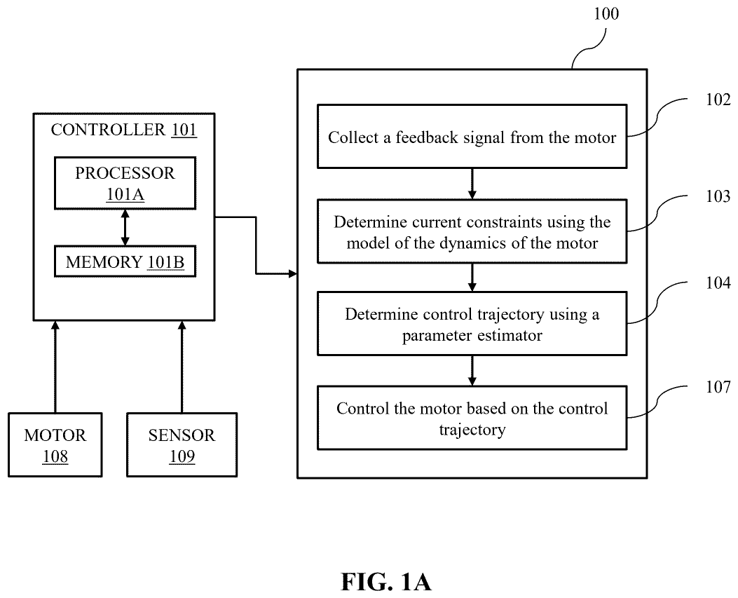

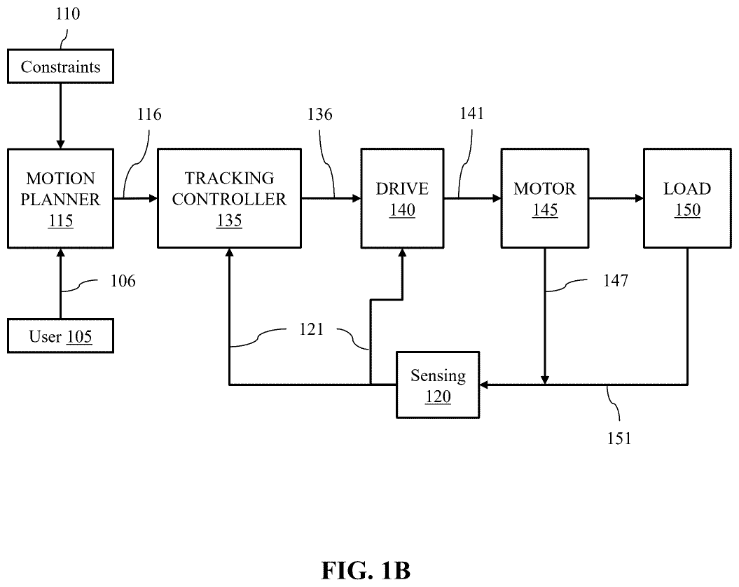

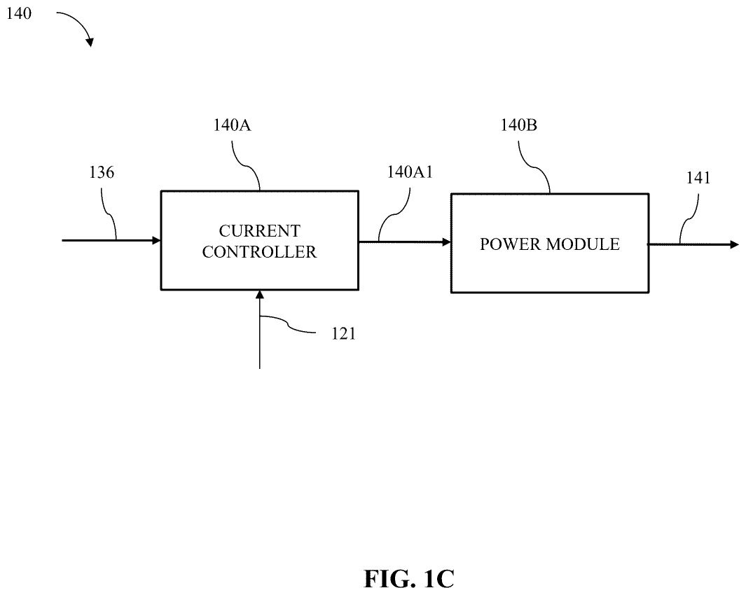

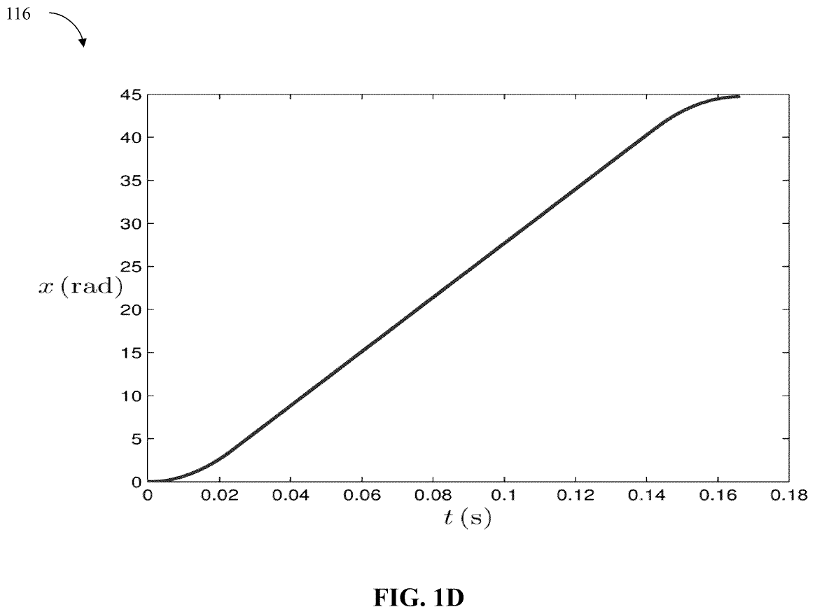

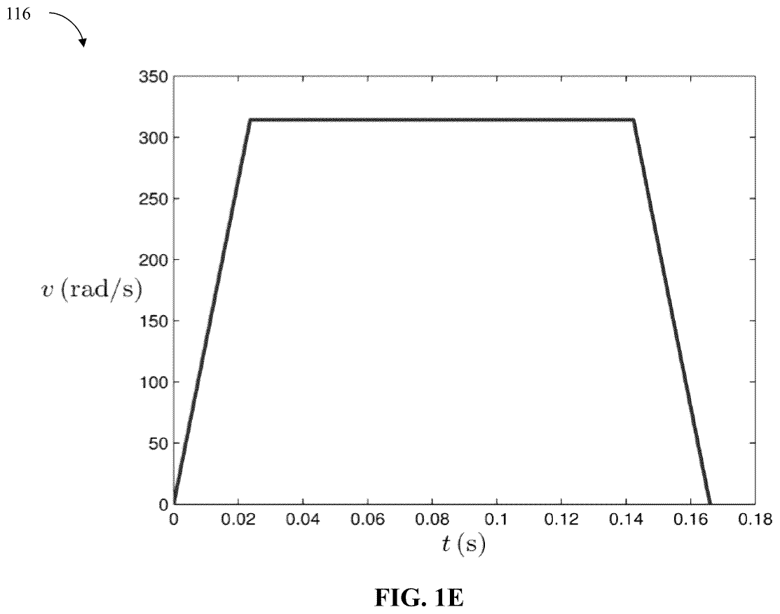

FIG. 1A shows one embodiment of a controller 101 designed for controlling the operation of a motor 108. The controller 101 comprises a processor 101A and a memory 101B having instructions stored thereon. The processor 101A executes the instructions to perform a series of steps 100 to effectively manage and regulate the motor's operation, ensuring it operates within defined parameters and under optimal conditions. The steps executed by the controller are described as follows.

The controller 101 begins by collecting 102 a feedback signal that is indicative of the current state of the motor's operation. The feedback signal includes measurements such speed of the motor 108, torque of the motor, position of the motor 108, current of the motor 108, voltage of the motor 108, or inductance of the motor 108. The feedback signal serves as a real-time representation of the motor's operational state and is essential for subsequent control steps. The feedback signal may be derived from one or more sensors 109 attached to the motor 108 or from other monitoring systems integrated within the motor's operation framework.

Upon acquiring the feedback signal, the controller 101 determines 103 the current constraints on various parameters of the motor's operation. This determination is made using a model of the motor's dynamics. The model of dynamics encapsulates the physical and operational relationships that govern the motor's behaviour, connecting the current state with the potential constraints that are present. These constraints include, limitations speed of the motor 108, acceleration of the motor 108, torque of the motor 108, or inductance of the motor 108.

After establishing the current constraints, the controller 101 proceeds to determine 104 a control trajectory for the motor's operation. The control trajectory represents a planned sequence of control actions that guide the motor 108 from its current state towards a desired target state. The control trajectory is determined based on the previously identified constraints but is calculated using a parametrized estimation that is agnostic to the detailed dynamics of the motor 108. The parametrized estimation involves in altering the parametrized reference trajectory by reshaping it based on the current constraints.

Finally, the controller 101 controls 107 the motor 108 based on the control trajectory by implementing the control trajectory to manage the motor's operation. The control signals generated by the controller 101 are applied to the motor's drive system, which includes motor control hardware. By following the control trajectory, the motor 108 is guided through its operational states in a manner that respects the identified constraints, thereby achieving the desired trajectory. The control process may be continuous or discrete, with the controller 101 repeatedly adjusting the control signals based on updated feedback signals, thus ensuring real-time adaptability to changing conditions.

FIG. 1B illustrates a block diagram of a motion control system where at least one electric motor 145 is employed as a force or torque actuator to drive a load 150 from an initial state to a target state accurately and quickly. A user 105 specifies task information 106 for example by providing an input through a suitable interface. The task information 106 defines a target state for the load 150. Using the target state, constraints 110, and model of the electric motor, a motion planner 115 determines a reference trajectory 116. A sensing module 120 senses the state 147 of the motor 145 and the state 151 of the load 150. A tracking controller 135 receives the reference trajectory 116 and signal 121 (indicative of state of the motor system) from the sensing module 120 and outputs a command signal 136 to drive unit 140. With the command signal 136 and the sensed signal 121, the drive unit 140 determines voltages 141 to power the motor 145 which is mechanically coupled with the load 150 so that the load 150 is moved towards the target state.

In some embodiments, the task information 106 comprises the target location and a preferred task completion time t_{f} of a machine tool which moves in a task space. In some embodiments, the task space is one dimensional, for example, corresponding to the horizontal x-axis of the Cartesian coordinates, or two dimensional, corresponding to the 2D plane defined by the horizontal x-axis and vertical y-axis of the Cartesian coordinates. To perform a task which requires to move the load 150 in multiple dimensions, multiple motors may typically be used, wherein each motor is used to drive the movement in an individual dimension.

In some embodiments, the motor 145 is a type of surface-mounted permanent magnet synchronous motor (SPMSM). The dynamics of the motor 145 and the load 150 in a particular dimension can be modeled as follows

$$\dot{x} = [ \begin{matrix}\begin{matrix}\begin{matrix}\begin{matrix}\dot{{I}_{d}} \\ \dot{{I}_{q}}\end{matrix} \\ \dot{ω}\end{matrix} \\ \dot{s}\end{matrix} \\ \dot{v}\end{matrix} ] = [ \begin{matrix}\frac{1}{{L}_{d}} ( - {Ri}_{d} + p ω {L}_{q} {i}_{q} + {u}_{d} ) \\ \frac{1}{{L}_{q}} ( - {Ri}_{q} - ( {L}_{d} {i}_{d} + {Φ}_{pm} ) p ω + {u}_{q} ) \\ {J}^{- 1} 1.5 p {Φ}_{pm} {i}_{q} \\ v \\ τ Z\end{matrix} ] , \qquad ( 1 )$$

where notations are summarized in Table 1; x≙[i_{d} i_{q} ω s v]^{T}∈ [symbol] ⁵ is the state; u≙[u_{d} u_{q}]^{T}∈ [symbol] ² is the control; Z>0 is a known gear ratio. Denote τ≙1.5pΦₚₘi_{q} as the motor torque and a ° TZ as the machine tool acceleration. s and v are the motion states. A fact from available knowledge is that v=Zω.

### Symbols Used in the SPMSM Model.

| Symbol | Description | Sym. | Description |
|---|---|---|---|
| L_{d}, L_{q} | inductance in d- and q-axis | ω | rotor angular velocity |
| I_{d}, I_{q} | current in d- and q-axis | s | machine tool position |
| u_{d}, u_{q} | voltage in d- and q-axis | v | machine tool velocity |
| Φₚₘ | permanent magnet flux | J | motor rotor inertia + |
| | | | load inertia |
| Vₘₐₓ | max DC bus voltage | p | number of pole pairs |
| Iₘₐₓ | max current | R | winding resistance |

Subscript _{des} indicates desired value; hat \hat{ } indicates value estimate; tilde ^{˜} indicates estimate error.

In some embodiments, the target state in task 106 is parameterized by s(t_{f})=s_{f}, v(t_{f})=0 and a given finite final time t_{f}. The initial state, without loss of generality, is parameterized by s(0)=0, v(0)=0. The motion planner 115 is configured to generate a reference trajectory to move the load 150 from the initial state to the target state within t_{f}.

In some embodiments, the user 105 hopes to accomplish a task as quick as possible, which means the final time t_{f} may not be explicitly given by user.

The constraints 110 characterize the restriction on kinematic variables of the motion control system such as velocity and acceleration of motor (or equivalently load), where the velocity and acceleration are bounded by certain pre-defined curves—typically constant curves or piece wisely linear curves. Alternately, the constraints 110 may be represented as pre-defined piece wisely linear functions to characterize the restriction on motor torque capacity. The motion planner 115 determines the reference trajectory 116 based on the pre-defined constraint functions, wherein FIGS. 1D and 1E give an example of the (angular) position and velocity profiles of the (motor) load over time. To quickly generate the reference trajectory, the motion planner 115 generally cannot include any dynamical information or complex constraints which explain the use of constant or piecewise constant constraints.

Some embodiments are based on the realization that the pre-defined functions representing constraints 110 are not accurately, and thus available solutions have to either 1) introduce a sufficiently large safety margin in the motion planner to ensure the reference trajectory 116 is always dynamically feasible—i.e., slow down the motion unnecessarily and sacrifice the productivity; or 2) risk the feasibility by imposing a smaller safety margin in the motion planner—i.e., potentially sacrifice the product quality. It is an object of this invention to provide a method to infer the constraints 110 accurately and thus reduce the size of safety margin while maintaining dynamic feasibility of the reference trajectory.

Some embodiments are based on the realization that the constraints 110 are not stationary over time, instead they are dependent on the dynamic model, operation history, and operation conditions of the motion control system, wherein the dynamic model parameters change during operation. It is object of some embodiments to learn the constraints online and generate the motion profile accordingly. These pre-defined constraints functions do not faithfully reflect the constraints during operation.

In some embodiments, the dynamic model parameters β≙[L_{d} L_{q} φₚₘ]T are unknown or change whereas parameters p, R are treated as known.

In some embodiments, the operation conditions include the maximum voltage Vₘₐₓ powering the drive unit 140 to generate voltage 141 and the maximum current Iₘₐₓ that the motor can sustain. In reality, the operation constraints of the system are given by

$${i}_{d}^{2} + {i}_{q}^{2} \leq {I}_{max}^{2} , {u}_{d}^{2} + {u}_{q}^{2} \leq {V}_{dq , max}^{2} , - {ω}_{m} ( β ) \leq ω \leq {ω}_{m} ( β ) ,$$

where V_{dq,max}≙Vₘₐₓ/\sqrt{3}−RIₘₐₓ>0 is the maximum voltage dropping to overcome back-EMF (counter-electromotive force); ωₘ(β) is the motor's max angular velocity, which is a function of motor parameters β. Consideration of such constraints in the motion planner 115 for reference trajectory generation is time-consuming.

In some embodiments, sensing signal 121 include the phase currents of the motor 145, the angular position of the motor shaft, and the position of the load 150.

In some embodiments, the tracking controller 135, comparing the sensed signal 121 against the reference trajectory, implements a proportional, integral and derivative (PID) control strategy or its variants to determine the command signal 136 in the form of reference torque for the motor 145 to produce.

FIG. 1C shows one embodiment of the drive unit 140 which includes a current controller 140A and a power module 140B (also termed voltage source inverter). The current controller 140A taking the reference torque 136 from the trajectory tracking controller 135, executes a control algorithm to determine phases voltage command 140A1 that the power module 140B should supply to the motor 145. The output phase voltage 141 of the power module 140B tries to track the voltage command 140A1 it receives. In some embodiments, the current controller 140A first implements a minimum copper loss control strategy to determine reference currents that the motor 145 shall produce and then another vector control strategy to determine the reference voltage 140A1 to ensure the motor current follows the reference currents.

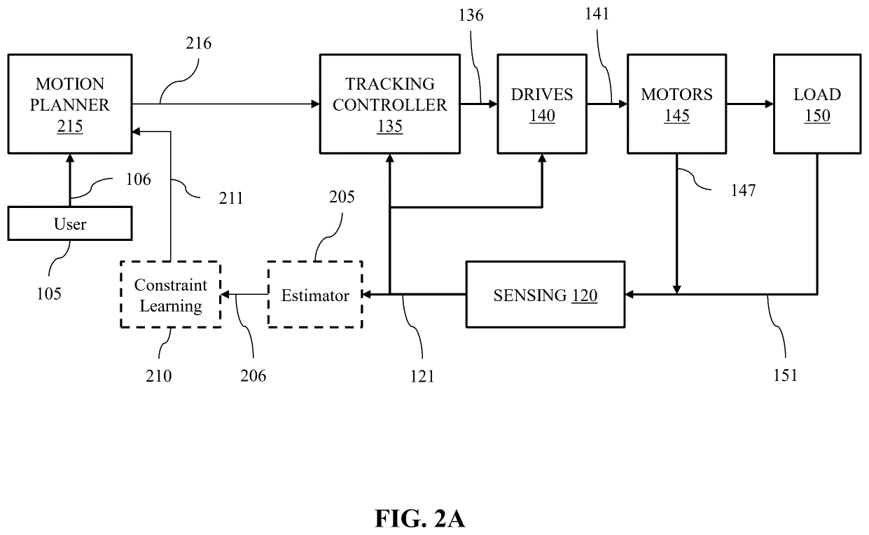

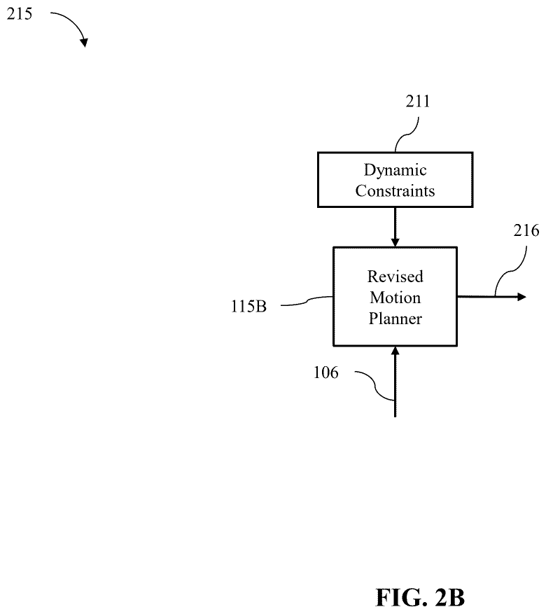

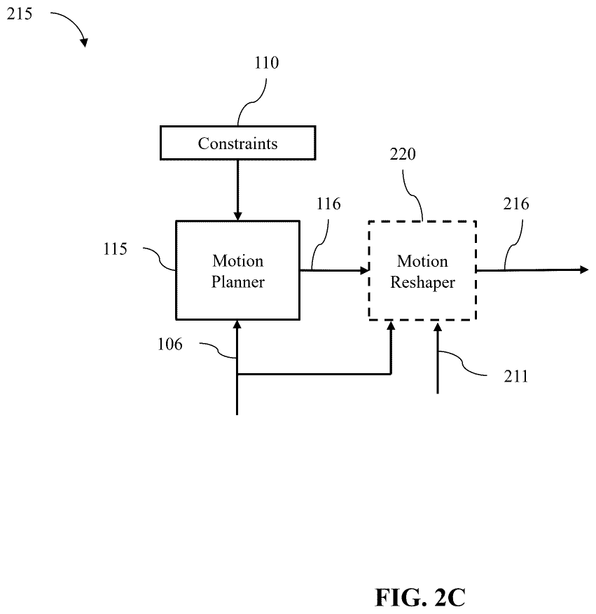

FIG. 2A discloses a framework of implementing a fast motion control system wherein the constraints 110 are learned and constructed online and used to generate a fast and dynamically feasible reference trajectory 216. Description of the components that are common to FIG. 1B is not repeated for the sake of brevity. An estimator 205 estimates the unknown parameters β of the dynamic model and based on the known parameters such as p, R, Vₘₐₓ, Iₘₐₓ and the estimated parameters \hat{β}, constraint learning module 210 constructs the dynamic torque constraints 211 for the motion planner 215 to use for the generation of the reference trajectory 216.

FIG. 2B illustrates one embodiment of motion planner 215 according to some embodiments. Dynamic constraints 211 and task information 106 are submitted to a revised motion planner 115B which computes the dynamic feasible reference trajectory 216 by solving a constrained optimal control problem.

FIG. 2C teaches one embodiment of the motion planner 115 according to some embodiments, wherein the motion planner 115 determines the reference trajectory 116 which may be dynamically infeasible because the constraints 110 only considers a small safety margin. A motion reshaper 220 processes task 116 based on the dynamic constraints to produce the dynamically feasible reference trajectory 216.

According to some embodiments, although fluctuating by temperature, R is not treated as an unknown parameter. This is because its fluctuation merely contributes to ˜1% of torque capacity uncertainty. This invention discloses the embodiment when the torque load is positive.

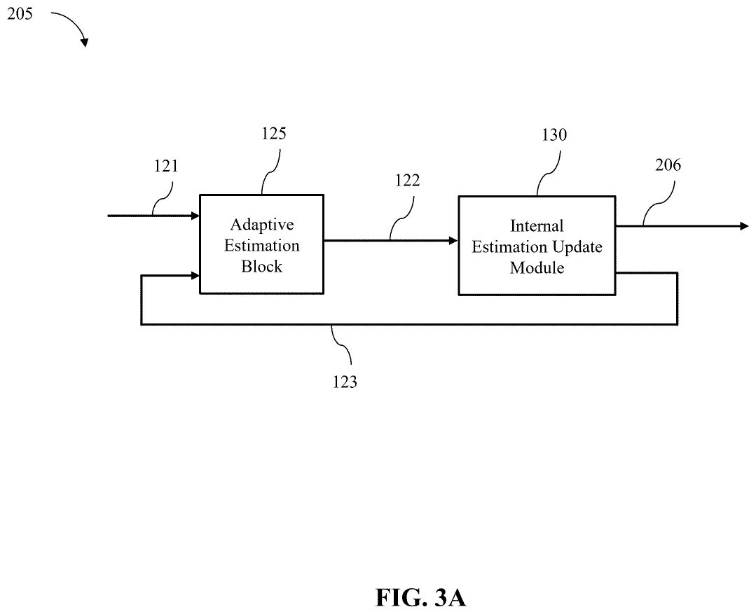

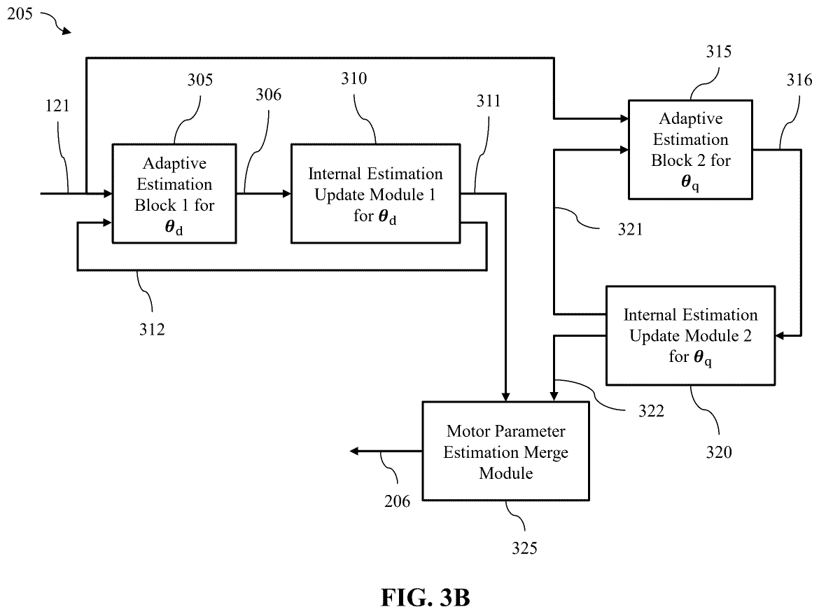

FIG. 3A discloses an embodiment of estimator 205 according to some embodiments. The adaptive estimation block 125 collects the sensed signal 121 and the internal estimated signal 123 as input and returns the estimated time derivative signal 122. Then, the internal estimation update module 130 takes in the estimated time derivative signal 122 and returns the estimated motor parameters 206 and the internal estimated signal 123.

In some embodiments, the adaptive estimation block 125 reparametrizes the motor model parameters β that need to be estimated as

$$θ {=}^{Δ} {[ {θ}_{d}^{T} {θ}_{q}^{T} ]}^{T} ∈ {ℝ}^{5} , \\ where {θ}_{d} {=}^{Δ} {[ \frac{1}{{L}_{d}} \frac{{L}_{q}}{{L}_{d}} ]}^{T} ∈ {ℝ}^{2} and {θ}_{q} {=}^{Δ} {[ \frac{1}{{L}_{q}} \frac{{L}_{d}}{{L}_{q}} \frac{{Φ}_{pm}}{{L}_{q}} ]}^{T} ∈ {ℝ}^{3} .$$

Thus, the motor current dynamics, i.e. the first two rows of (1), can be rewritten in linearly parameterized form, particularly,

$${i}_{d} = {ψ}_{d} {θ}_{d} = ( - R {i}_{d} + {u}_{d} ) \frac{1}{{L}_{d}} + p ω {i}_{q} \frac{{L}_{q}}{{L}_{d}} , {i}_{q} = {ψ}_{q} {θ}_{q} = ( - R {i}_{q} + {u}_{q} ) \frac{1}{{L}_{q}} - p ω {i}_{d} \frac{{L}_{d}}{{L}_{q}} - p ω \frac{{Φ}_{p m}}{{L}_{q}} , \qquad ( 2 )$$

where ψ_{d} ≙[−Ri_{d}+u_{d} pωi_{q}]∈ [symbol] ^{1×2} and ψ_{q}≙[−Ri_{q}+u_{q}−pωi_{d}−pω]∈ [symbol] ^{1×3}. The adaptive estimation block 125 formulates an adaptive parameter estimation rule as follows:

$${\dot{\hat{ι}}}_{d} = {ψ}_{d} {\hat{θ}}_{d} + {μ}_{d}^{T} {\dot{\hat{θ}}}_{d} + {K}_{{L}_{d}} ( {i}_{d} - {\hat{ι}}_{d} ) , {\dot{\hat{θ}}}_{d} = {Γ}_{d} {μ}_{d} ( {i}_{d} - {\hat{ι}}_{d} ) , {\dot{μ}}_{d} = - {K}_{{L}_{d}} {μ}_{d} + {ψ}_{d}^{T} , {\dot{\hat{ι}}}_{q} = {ψ}_{q} {\hat{θ}}_{q} + {μ}_{q}^{T} {\dot{\hat{θ}}}_{q} + {K}_{{L}_{q}} ( {i}_{q} - {\hat{ι}}_{q} ) , {\dot{\hat{θ}}}_{q} = {Γ}_{q} {μ}_{q} ( {i}_{q} - {\hat{ι}}_{q} ) , {\dot{μ}}_{q} = - {K}_{{L}_{q}} {μ}_{q} + {ψ}_{q}^{T} , \qquad ( 3 )$$

here K_{L}_{_{d}}, K_{L}_{_{q}}>0 are some prescribed observer gains, μ_{d}∈ [symbol] ², μ_{q}∈ [symbol] ³ are the states of the observer, representing the adaptive gain vectors, and \hat{θ}_{d}∈ [symbol] ² and \hat{θ}_{q}∈ [symbol] ³ are the estimation of θ. Γ_{d}∈ [symbol] ^{2×2} and Γ_{q}∈ [symbol] ^{3×3} are some positive definite adaptation gain matrices. One can rewrite the dynamics of estimated d- and q-currents, denoted as \hat{ι}_{d}, \hat{ι}_{q}, in (3), as follows:

$${\dot{\hat{ι}}}_{d} = {ψ}_{d} {\hat{θ}}_{d} + ( {μ}_{d}^{T} {Γ}_{d} {μ}_{d} + {K}_{{L}_{d}} ) ( {i}_{d} - {\hat{ι}}_{d} ) , {\dot{\hat{ι}}}_{q} = {ψ}_{q} {\hat{θ}}_{q} + ( {μ}_{q}^{T} {Γ}_{q} {μ}_{q} + {K}_{{L}_{q}} ) ( {i}_{q} - {\hat{ι}}_{q} ) .$$

The sensed signal 121 passes ψ_{d}, ψ_{q}, μ_{d}, μ_{q}, i_{d}, i_{q} to the adaptive estimation block 125. The adaptive estimation block 125 returns the estimated time derivative signal 122, i.e. \dot{i}_{d}, \dot{i}_{q}, \dot{\hat{θ}}_{d}, \dot{\hat{θ}}_{q}, \dot{μ}_{d}, \dot{μ}_{q}.

In some embodiments, the internal estimation update module 130 updates the internal estimated signal 123, i.e. \hat{ι}_{d}, \hat{ι}_{q}, \hat{θ}_{d}, \hat{θ}_{q}, μ_{d}, μ_{q}, as follows:

$${\hat{ι}}_{d} ( t + 1 ) = {\hat{ι}}_{d} ( t ) + δ {\dot{\hat{ι}}}_{d} ( t ) , {\hat{ι}}_{q} ( t + 1 ) = {\hat{ι}}_{q} ( t ) + δ {\dot{\hat{ι}}}_{q} ( t ) , {\hat{θ}}_{d} ( t + 1 ) = {\hat{θ}}_{d} ( t ) + δ {\dot{\hat{θ}}}_{d} ( t ) , {\hat{θ}}_{q} ( t + 1 ) = {\hat{θ}}_{q} ( t ) + δ {\dot{\hat{θ}}}_{q} ( t ) , {μ}_{d} ( t + 1 ) = {μ}_{d} ( t ) + δ {\dot{μ}}_{d} ( t ) , {μ}_{q} ( t + 1 ) = {μ}_{q} ( t ) + δ {\dot{μ}}_{q} ( t ) , \qquad ( 4 )$$

where δ>0 is a prescribed time step. Then, the internal estimation update module 130 returns the estimated motor parameters 206 as follows:

$$\hat{β} {=}^{Δ} {[ 1 / {\hat{θ}}_{d} [ 1 ] 1 / {\hat{θ}}_{q} [ 1 ] {\hat{θ}}_{q} [ 3 ] / {\hat{θ}}_{q} [ 1 ] ]}^{T} ,$$

where \hat{θ}_{d}[1] denotes the first element of the vector \hat{θ}_{d}; the other notations apply the similar rule.

In some embodiments for SPMSM motors with L_{d}=L_{q}, the adaptive estimation block 125 reparameterizes the motor model parameters β that need to be estimated as

$$θ {=}^{Δ} {[ {θ}_{d}^{T} {θ}_{q}^{T} ]}^{T} ∈ {ℝ}^{2} , where {θ}_{d} {=}^{Δ} \frac{1}{{L}_{d}} and {θ}_{q} {=}^{Δ} \frac{{Φ}_{pm}}{{L}_{q}} .$$

Thus, the motor current dynamics, i.e. the first two rows of (1), can be rewritten in linearly parameterized form, particularly,

$${i}_{d} = {ψ}_{d} {θ}_{d} + p ω {i}_{q} = ( - R {i}_{d} + {u}_{d} ) \frac{1}{{L}_{d}} + p ω {i}_{q} , {i}_{q} = ( - R {i}_{q} + {u}_{q} ) \frac{1}{{L}_{q}} - p ω {i}_{d} + {ψ}_{q} {θ}_{q} = ( - R {i}_{q} + {u}_{q} ) \frac{1}{{L}_{d}} - p ω {i}_{d} - p ω \frac{{Φ}_{pm}}{{L}_{d}} ,$$

where ψ_{d}≙−Ri_{d}+u_{d} and ψ_{q}≙−pω. The adaptive estimation block 125 formulates the same adaptive parameter estimation rule as above, but with updated definitions of ψ_{d}, ψ_{q}, θ_{d}, θ_{q}, μ_{d}, μ_{q}.

FIG. 3B teaches another embodiment of estimator 205 according to some embodiments, which sequentially estimates the motor parameter. First, the adaptive estimation block 1 for θ_{d} 305 takes in the sensed signal 121 and the internal estimated signal for θ_{d} 312; and returns the estimated time derivative signal for θ_{d}306. Second, the internal estimation update module 1 for θ_{d} 310 takes in 306 and returns the partial motor parameter estimate 311 and the updated internal estimated signal for θ_{d} 312. Third, the adaptive estimation block 2 for θ_{q} 315 takes in the sensed signal 121 and the internal estimated signal for θ_{q} 321; and returns the estimated time derivative signal for θ_{q} 316. Fourth, the internal estimation update module 2 for θ_{q} 320 takes in 316 and returns the updated internal estimated signal for θ_{q} 321 and the partial motor parameter estimate 322. Finally, the motor parameter estimation merge module 325 takes in the partial motor parameter estimate 311 and the partial motor parameter estimate 322; and returns the estimated motor parameter 206.

In some embodiments, the adaptive estimation block 1 for θ_{d} 305 calculates the estimated time derivative signal for θ_{d} 306, i.e., \dot{\hat{ι}}_{d}, \dot{\hat{θ}}_{d}, \dot{μ}_{d}, as follows:

$${\dot{\hat{ι}}}_{d} = {ψ}_{d} {\hat{θ}}_{d} + ( {μ}_{d}^{T} {Γ}_{d} {μ}_{d} + {K}_{{L}_{d}} ) ( {i}_{d} - {\hat{ι}}_{d} ) , {\dot{\hat{θ}}}_{d} = {Γ}_{d} {μ}_{d} ( {i}_{d} - {\hat{ι}}_{d} ) , {\dot{μ}}_{d} = - {K}_{{L}_{d}} {μ}_{d} + {ψ}_{d}^{T} .$$

The internal estimation update module 1 for θ_{d} 310 calculates 312, i.e., \hat{ι}_{d}, \hat{θ}_{d}, μ_{d} by the 1^{st}, 3^{rd} and 5^{th} equations in (4). The partial motor parameter estimates 311 returned by 310 is 1/\hat{θ}_{d}[1]. The adaptive estimation block 2 for θ_{q} 315 calculates the estimated time derivative signal for θ_{q} 316, i.e., \dot{\hat{ι}}_{q}, \dot{\hat{θ}}_{q}, \dot{μ}_{q}, as follows:

$${\dot{\hat{ι}}}_{q} = {ψ}_{q} {\hat{θ}}_{q} + ( {μ}_{q}^{T} {Γ}_{q} {μ}_{q} + {K}_{{L}_{q}} ) ( {i}_{q} - {\hat{ι}}_{q} ) , {\dot{\hat{θ}}}_{q} = {Γ}_{q} {μ}_{q} ( {i}_{q} - {\hat{ι}}_{q} ) , {\dot{μ}}_{q} = - {K}_{{L}_{q}} {μ}_{q} + {ψ}_{q}^{T} .$$

The internal estimation update module 2 for θ_{q} 320 calculates \hat{ι}_{q}, \hat{θ}_{q}, μ_{q} by the 2^{nd}, 4^{th} and 6^{th} of equations in (4). The partial motor parameter estimates 322 returned by 320 is 1/\hat{θ}_{q}[1] and \hat{θ}_{q}[3]/\hat{θ}q[1]. The motor parameter estimation merge module 325 generates the estimated motor parameter 206 given 311 and 322 as follows:

$$\hat{β} {=}^{Δ} {[ 1 / {\hat{θ}}_{d} [ 1 ] 1 / {\hat{θ}}_{q} [ 1 ] {\hat{θ}}_{q} [ 3 ] / {\hat{θ}}_{q} [ 1 ] ]}^{T} ,$$

where the first element of \hat{β} is from 311, and the second and third element of \hat{β} is from 322.

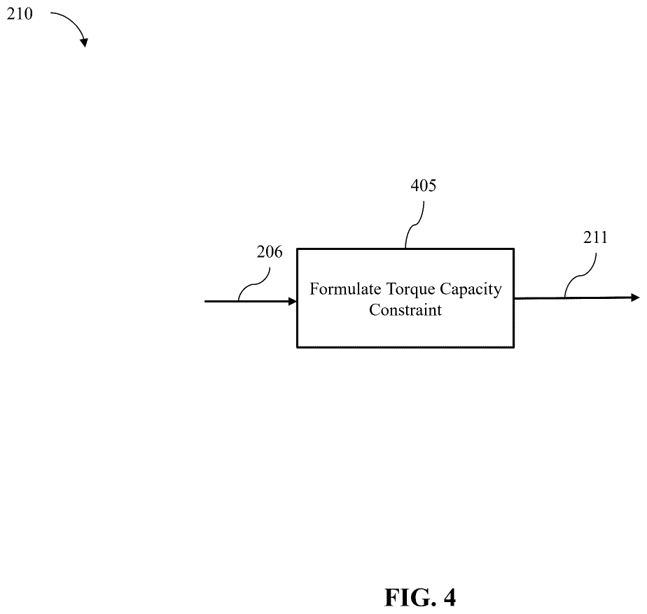

FIG. 4 illustrates one embodiment of motor torque capacity constraint learning 210 according to this invention. A torque capacity constraint formulation block 405 takes the estimated motor parameter 206 as input and returns the dynamic torque constraint 211.

In some embodiment, the torque capacity constraint formulation block 405 involves constructing analytical functions as torque constraints with a common max torque per ampere control (MTPA) strategy for motors. Under this strategy, the motor torque bound can be represented as various analytic functions of speed according to three cases, depending on the sign of Φₚₘ/L_{d}−Iₘₐₓ. When Φₚₘ/L_{d}−Iₘₐₓ=0, the maximum motor torque function τₘ(ω, β) is given by

$${τ}_{m} ( ω , β ) = \{ \begin{matrix}1.5 p {Φ}_{pm} {I}_{max} , & if \vert ω \vert \leq {ω}_{r} \\ 1.5 p {Φ}_{pm} {i}_{q , lim} , & if \vert ω \vert ∈ [ {ω}_{r} , ∞ )\end{matrix} \\ where {ω}_{r} ( β ) and {i}_{q , lim} ( ω , β ) are given by \qquad ( 5 )$$

$${ω}_{r} = \frac{{V}_{dq , max , j}}{p \sqrt{{( {L}_{q} {I}_{max} )}^{2} + {Φ}_{pm}^{2}}} \qquad ( 6 a )$$

$${i}_{q , lim} = \sqrt{{I}_{max}^{2} - {i}_{d , lim}^{2}} \qquad ( 6 b )$$

$${i}_{d , lim} = \frac{{( {V}_{dq , max} / ( p ω ) )}^{2} - {( {L}_{d} {I}_{max} )}^{2} - {Φ}_{pm}^{2}}{2 {Φ}_{pm} {L}_{d}} \\ where {Φ}_{p m} / {L}_{d} - {I}_{max} > 0 , {τ}_{m} ( ω , β ) is given by \qquad ( 6 c )$$

$${τ}_{max} ( ω , β ) = \{ \begin{matrix}1.5 p {Φ}_{pm} {I}_{max} , & if \vert ω \vert \leq {ω}_{r} , \\ 1.5 p {Φ}_{pm} {i}_{q , lim} , & if \vert ω \vert ∈ [ {ω}_{r} , {ω}_{max} ] ,\end{matrix} \qquad ( 7 )$$

where ωᵣ and i_{q,lim} are given by (6a) and (6c), respectively; and ωₘₐₓ is

$${ω}_{max} {=}^{Δ} \frac{{V}_{dq , max}}{p \vert {Φ}_{pm} - {L}_{d} {I}_{max} \vert} . When {Φ}_{p m} / {L}_{d} - {I}_{max} < 0 , {τ}_{m} ( ω , β ) is given by {τ}_{max} ( ω , β ) = \{ \begin{matrix}1.5 p {Φ}_{pm} {I}_{max} , & if \vert ω \vert \leq {ω}_{r} , \\ 1.5 p {Φ}_{pm} {i}_{q , lim} , & if \vert ω \vert ∈ [ {ω}_{r} , {ω}_{s} ] , \\ 1.5 p {Φ}_{pm} {i}_{q , lim , V} , & if \vert ω \vert ∈ [ {ω}_{r} , ∞ ) ,\end{matrix} \qquad ( 8 )$$

where ωᵣ and i_{q,lim} are given by (6a) and (6c), respectively; ωₛ is given by

$${ω}_{s} {=}^{Δ} \frac{{V}_{dq , max}}{p \sqrt{{( {L}_{d} {I}_{max} )}^{2} - {Φ}_{p m}^{2}}} ,$$

and i_{q,lim,v} is given by

$${i}_{q , lim , V} = {V}_{dq , max} / ( {ω}_{e} {L}_{q} ) .$$

The dynamic torque constraint 211 follows one of three sets of equations, i.e. (5), (7), and (8), to generate motor torque capacity as a function of motor speed and estimated motor parameter 206, depending on the sign of estimated Φₚₘ/L_{d}−Iₘₐₓ.

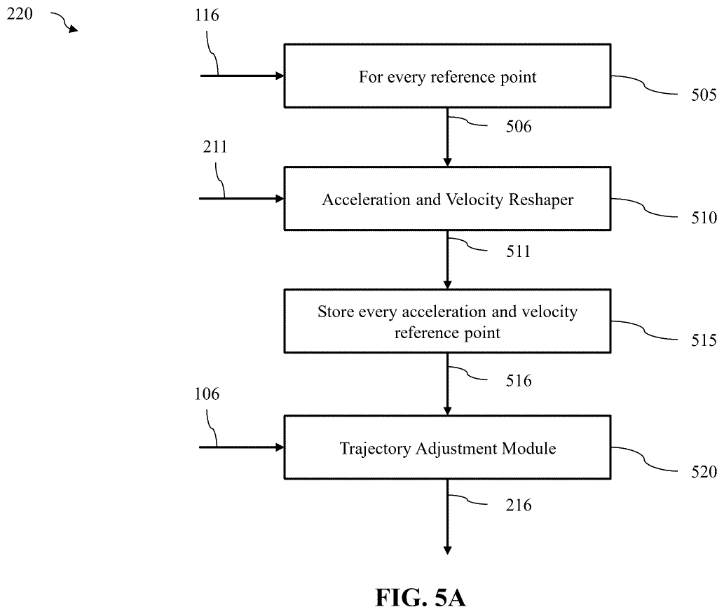

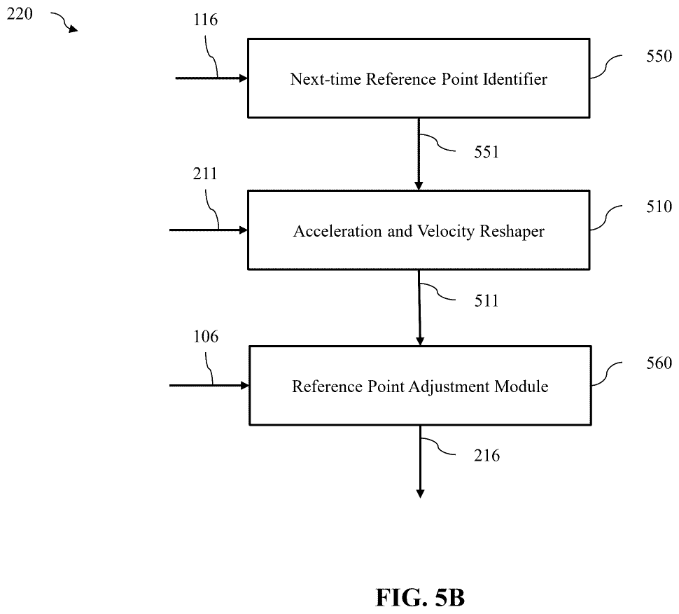

According to some embodiments, the motion reshaper 220 is implemented as a reference governor accepting dynamically varying constraints on the operation of the motor. FIG. 5A discloses a method of implementing motion reshaper 220 according to this invention, which reshapes the entire reference trajectory 116. First, given the reference trajectory 116, the module 505 finds every reference point at each time step k 506, which includes the desired velocity vₖ at time k and the desired acceleration a_{des,k+1} at next timestamp k+1. Then the module 505 passes every reference point at each time step k 506 to the acceleration and velocity reshaper 510. Second, given the dynamic torque constraint 211, the acceleration and velocity reshaper 510 reshapes every desired acceleration 506 and its corresponding velocity as the reshaped feasible reference acceleration and velocity 511. Third, the module 515 stores the reshaped acceleration and velocity 511 from the acceleration and velocity reshaper 510 for every point of the entire reference trajectory 116 and returns a reshaped reference trajectory of acceleration and velocity 516. To ensure that the target position s_{f} in 106 is reached with zero final velocity in the reshaped reference trajectory 516, the reshaped reference trajectory 516 and the task information 106 are then passed to the trajectory adjustment module 520. Finally, the adjusted and reshaped reference trajectory 216 is passed from the trajectory adjustment module 520 to the tracking controller 135.

FIG. 5B discloses another method of implementing motion reshaper 220 according to this invention, which reshapes one point of the reference trajectory 116. First, given the reference trajectory 116, at every present time k, the next-time reference point identifier 550 finds the next reference point to be tracked 506, which includes the desired velocity vₖ at time k and the desired acceleration a_{des,k+1} at next timestamp k+1. Then the next-time reference point identifier passes 506 to the acceleration and velocity reshaper 510. Second, given the dynamic torque constraint 211, the acceleration and velocity reshaper 510 reshapes the desired acceleration 506 and its corresponding velocity as the reshaped feasible reference acceleration and velocity 511. To ensure that the overall reshaped reference trajectory that consists of every reshaped reference point 511 can reach the target position s_{f} in 106 with zero final velocity, each reshaped reference point 511 is passed to the reference point adjustment module 560. Then, the reference point adjustment module 560 returns every adjusted and reshaped reference acceleration and velocity of the reference trajectory 216.

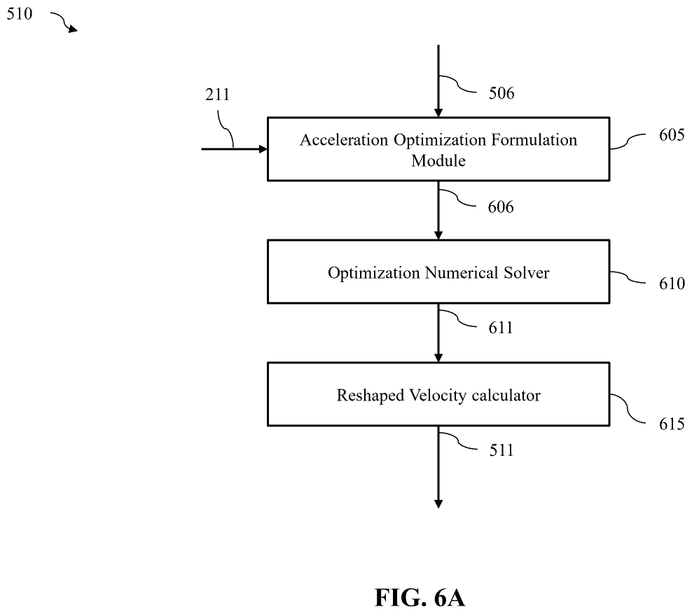

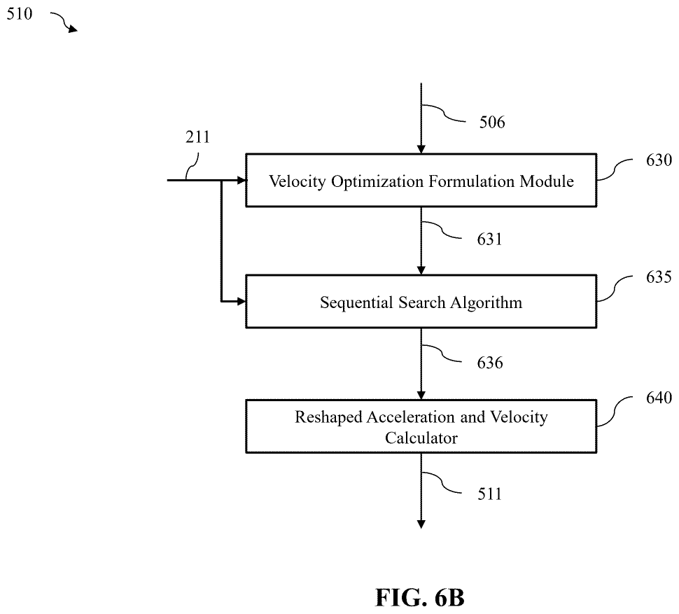

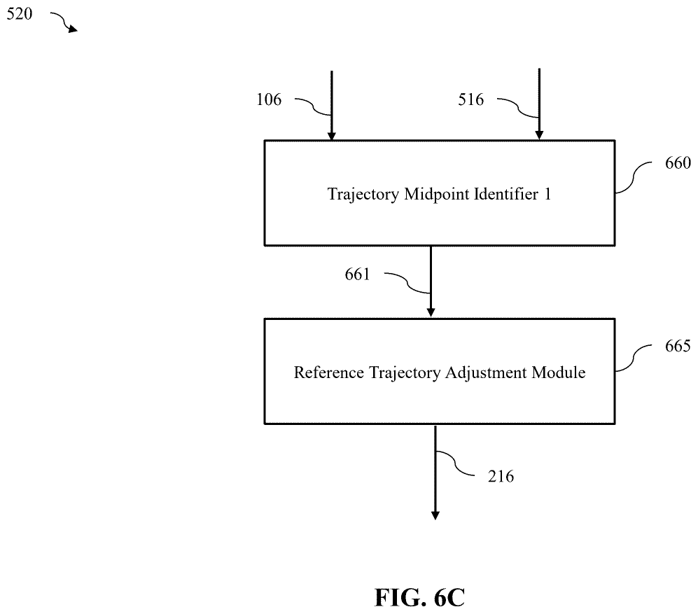

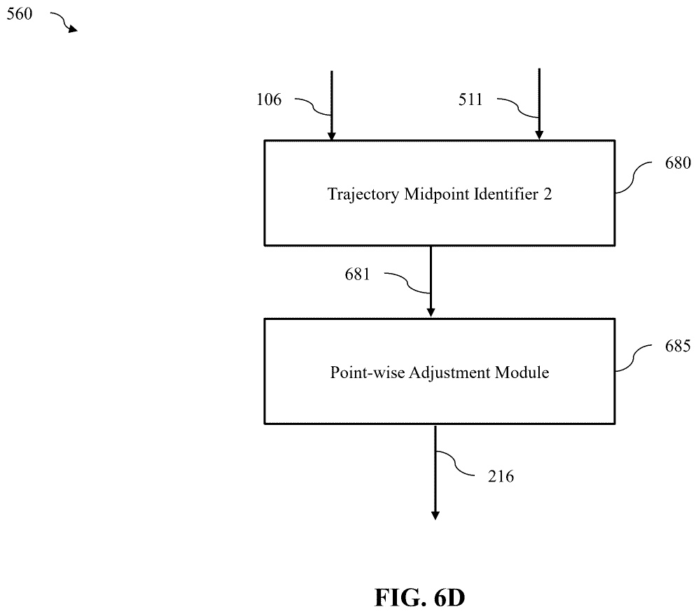

FIG. 6A illustrates one embodiment of the acceleration and velocity reshaper 510 according to some embodiments. First, the acceleration optimization formulation module 605 takes in the information 506 (i.e. the desired velocity vₖ at time k and the desired acceleration a_{des,k+1} at next timestamp k+1) and the dynamic torque constraint 211, formulates an acceleration optimization problem to revise the desired acceleration at next time, and passes one optimization problem instance 606 to the optimization numerical solver 610. Given the desired acceleration a_{des,k+1} from 506, the optimization problem finds the closest acceleration subject to the torque constraint at each time k, i.e.

$${a}_{k + 1}^{*} = arg {min}_{{a}_{k + 1}} {\vert {a}_{k + 1} - {a}_{des , k + 1} \vert}^{2}$$

$$subject to \vert \frac{{a}_{k + 1}}{Z} \vert \leq {τ}_{m} ( {ω}_{k + 1} ) ,$$

$${ω}_{k + 1} = \frac{{v}_{k} - Δ {a}_{k + 1}}{Z J}$$

Second, the optimization numerical solver 610 solves the optimization problem instance 606 and returns a reshaped desired acceleration a*ₖ₊₁ 611 at next timestamp k+1. Third, the reshaped velocity calculator 615 reshapes the desired velocity

$${v}_{k + 1}^{*}$$

at next timestamp k+1 given

$${a}_{k + 1}^{*} 611 ,$$

and returns both the reshaped acceleration and velocity 511 at next timestamp k+1 to the module 515. The calculation of

$${v}_{k + 1}^{*}$$

is given by

$${v}_{k + 1}^{*} = \frac{{v}_{k} + Δ {a}_{k + 1}^{*}}{J} .$$

FIG. 6B illustrates another embodiment of the acceleration and velocity reshaper 510 according to some embodiments. First, the velocity optimization formulation module 630 takes in the dynamic torque constraint 211 and the information 506 (which includes the desired velocity vₖ at time k and the desired acceleration a_{des,k+1} at next timestamp k+1); formulates a velocity optimization problem with the next timestamp motor velocity being the decision variable; and passes the velocity optimization problem instance 631 to the sequential search algorithm 635. The velocity optimization problem is written as follows, where the decision variable is the motor velocity ωₖ₊₁ at the next timestamp k+1:

$${min}_{{ω}_{k + 1}} F ( {ω}_{k + 1} ) := {\vert \frac{Z J}{Δ} {ω}_{k + 1} - \frac{{v}_{k}}{Δ} - {a}_{des , k + 1} \vert}^{2}$$

$$subject to \vert \frac{J}{Δ} {ω}_{k + 1} - \frac{v}{Z Δ} \vert \leq {γτ}_{m} ( {ω}_{k + 1} ) ,$$

$$- {ω}_{m} ( β ) \leq {ω}_{k + 1} \leq {ω}_{m} ( β )$$

where γ∈(0,1] is a prescribed constant. Second, the sequential search algorithm 635 takes in the optimization instance 631 and searches over a finite set of solution candidates to return the optimal and feasible motor velocity

$${ω}_{k + 1}^{*} 636 .$$

Third, the reshaped acceleration and velocity calculator 640 takes in the optimal motor velocity

$${ω}_{k + 1}^{*} 636$$

and calculates the desired acceleration

$${a}_{k + 1}^{*}$$

and velocity

$${v}_{k + 1}^{*} 511 .$$

The calculation is given by

$${a}_{k + 1}^{*} = ( ZJ {ω}_{k + 1}^{*} - {v}_{k} ) / Δ , {v}_{k + 1}^{*} = \frac{{v}_{k} + Δ {a}_{k + 1}^{*}}{J} .$$

FIG. 6C discloses one embodiment of the trajectory adjustment module 520 which adjusts the entire reshaped reference trajectory to satisfy the boundary condition, i.e., the target position is reached with zero final velocity, according to some embodiments. First, the trajectory midpoint identifier 1 660 takes in the reshaped reference trajectory 516 and the target position s_{f} from the task information 106; and returns the information 661 that can identify the temporal midpoints of the reference trajectory where the acceleration changes the sign. Then, the reference trajectory adjustment module 665 takes in the information 641 and returns the reshaped and adjusted reference trajectory 216 such that the reference trajectory reaches the target position with zero final velocity.

In some embodiments, the reference trajectory only contains one temporal midpoint which is identified by the time instance t_{mid} of the reshaped acceleration reference trajectory 516 where the acceleration changes the sign (i.e., from acceleration to deceleration). Then, the desired accumulative position to be traveled until time t_{mid} is:

$${p}_{mid} = {\int }_{0}^{{t}_{m i d}} {\int }_{0}^{{t}_{m i d}} {a}_{des}^{*} ( t ) d t .$$

And the additional traveling distance pᵣₑₛₜ that needs to be compensated is:

$${P}_{rest} = {s}_{f} - 2 {p}_{mid} .$$

Given the reshaped reference trajectory 516, the desired velocity at time t_{mid} can be found as v_{mid}. Then the additional time duration Δ_{mid} of traveling pᵣₑₛₜ with velocity v_{mid} is

$${Δ}_{mid} = \frac{{p}_{rest}}{{v}_{mid}} .$$

The necessary information 641 includes t_{mid}, Δ_{mid}, v_{mid}, and the reshaped reference trajectory 516, which is then passed to the reference trajectory adjustment module 645. The reference trajectory adjustment module 665 inserts an additional segment of the reference trajectory after the time instance t_{mid}, where the desired acceleration is zero, the desired velocity is v_{mid}, and the duration is from time t_{mid} until time t_{mid}+Δ_{mid}. The adjusted and reshaped reference trajectory 216 is then passed to the tracking controller 135.

FIG. 6D illustrates one embodiment of the reference point adjustment module 560 according to some embodiments. First, the trajectory midpoint identifier 2 680 takes in the reshaped reference point 511, the target position s_{f} from the task information 106, and the reference trajectory 116. Second, 680 calculates the accumulative desired traveling distance until the present time k as p_{ac}(k). Third, 680 checks whether the desired reshaped acceleration

$${a}_{des , k + 1}^{*}$$

at next timestamp k+1 has an opposite sign than the desired reshaped acceleration

$${a}_{des , k}^{*}$$

at present time k and generates a logic flag on whether this condition is satisfied. Then, the trajectory midpoint identifier 2 680 passes the necessary information 681, which includes p_{ac}(k), the present time k, the logic flag, and the desired velocity vₖ at present time k, to the point-wise adjustment module 685. Given the necessary information 681, the point-wise adjustment module 685 reads the logic flag. If the sign of

$${a}_{des , k + 1}^{*}$$

is the opposite of the sign of

$${a}_{des , k}^{*} ,$$

685 records the present time as t_{mid}, i.e., the temporal midpoint of the reference trajectory. Then the reshaped acceleration

$${a}_{des , k + 1}^{*}$$

at next time k+1 is adjusted to zero, and the reshaped velocity

$${v}_{k + 1}^{*}$$

is adjusted to vₖ. This process is performed for every reference point from time t_{mid} until another timestamp t_{mid,2} where the accumulative desired traveling distance p_{ac}(t_{mid,2})=0.5s_{f}. After reaching the timestamp t_{mid,2}, the point-wise adjustment module 685 directly returns the originally reshaped acceleration

$${a}_{des , k + 1}^{*}$$

and velocity

$${v}_{k + 1}^{*}$$

from 511 without any adjustment.

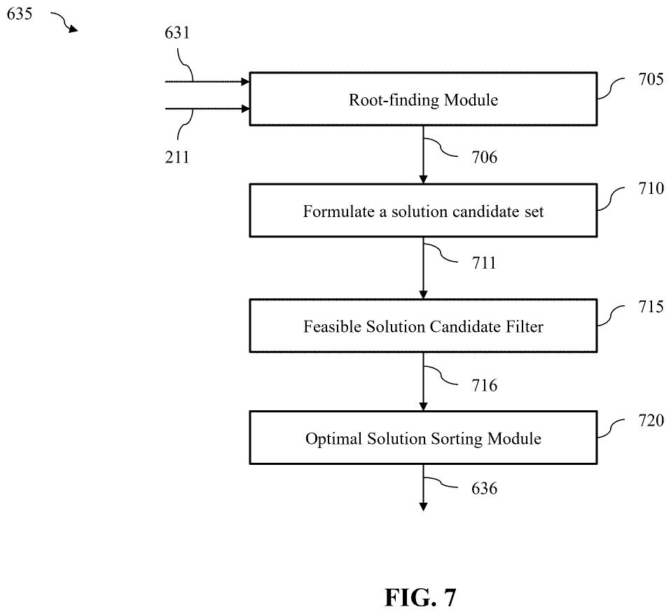

FIG. 7 illustrates one embodiment of the sequential search algorithm 635 according to some embodiments. First, given the velocity optimization problem 631 and the dynamic torque constraint 211, the root-finding module 705 finds two root sets 706, where one root set is

$${Ω}_{L} {=}^{Δ} \{ ω \vert {γτ}_{m} ( ω ) + ( \frac{J}{Δ} ω - \frac{{v}_{k}}{Z Δ} ) = 0 \}$$

and the another root set is

$${Ω}_{U} {=}^{Δ} \{ ω \vert {γτ}_{m} ( ω ) - ( \frac{J}{Δ} ω - \frac{{v}_{k}}{Z Δ} ) = 0 \} .$$

Given two root sets 706, the module 710 formulates a solution candidate set 711 by combining the following elements:

$$Ω = \{ \frac{{y}_{k} + Δ {a}_{des , k + 1}}{ZJ} \} ⋃ {Ω}_{U} ⋃ {Ω}_{L} ⋃ \{ \pm {ω}_{m} ( \hat{β} ) , {ω}_{k} \} ,$$

where Ω is the solution candidate set 711. Then, the solution candidate set 711 is passed to the feasible solution candidate filter 715 to generate a feasible candidate set 716. The feasible solution candidate set 716 is determined by the feasible solution candidate filter 715 checking the following conditions:

$$\overline{Ω} ← \{ ω ∈ Ω : \vert ω \vert \leq {ω}_{m} ( \hat{β} ) , \vert \frac{J}{Δ} ω - \frac{{y}_{k}}{Z Δ} \vert \leq {γτ}_{m} ( ω ) \} ,$$

where Ω̅ is the feasible solution candidate set 716. The feasible solution candidate set 716 is then passed to the optimal solution sorting module 720, where each feasible solution candidate ω in the set 716 is evaluated by

$$F ( ω ) = {\vert ( \frac{ZJ}{Δ} {ω}_{-} \frac{{v}_{k}}{Δ} ) - {a}_{des , k + 1} \vert}^{2}$$

and sorted by the value of F(ω). Finally, the ω in the set 716 that has the lowest value of F(ω) is the optimal motor velocity

$${ω}_{k + 1}^{*} 636.$$

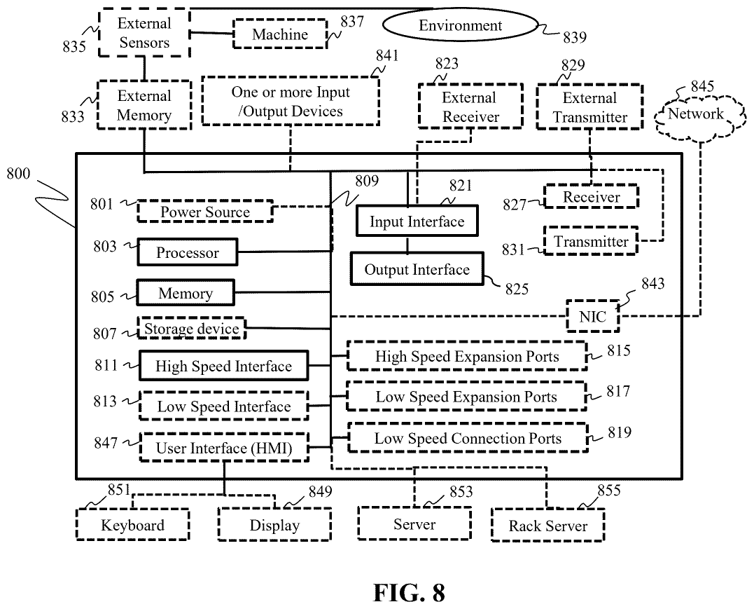

FIG. 8 shows a schematic diagram of some components of a control system 800 for controlling a motor, in accordance with some embodiments of the present disclosure. The control system 800 includes a power source 801, a processor 803, a memory 805, a storage device 807, all connected to a bus 809. Further, a high-speed interface 811, a low-speed interface 813, high-speed expansion ports 815 and low speed connection ports 817, can be connected to the bus 809. In addition, a low-speed expansion port 819 is in connection with the bus 809. Further, an input interface 821 can be connected via the bus 809 to an external receiver 823 and an output interface 825. A receiver 827 can be connected to an external transmitter 829 and a transmitter 831 via the bus 809. Also connected to the bus 809 can be an external memory 833, external sensors 835, machine(s) 837, and an environment 839. Further, one or more external input/output devices 841 can be connected to the bus 809. A network interface controller (NIC) 843 can be adapted to connect through the bus 809 to a network 845, wherein data or other data, among other things, can be rendered on a third-party display device, third party imaging device, and/or third-party printing device outside of the control system 800.

The memory 805 may store instructions that are executable by the control system 800 and any data that can be utilized by the methods and systems of the present disclosure. The memory 805 can include random access memory (RAM), read only memory (ROM), flash memory, or any other suitable memory systems. The memory 805 can be a volatile memory unit or units, and/or a non-volatile memory unit or units. The memory 805 may also be another form of computer-readable medium, such as a magnetic or optical disk.

The storage device 807 can be adapted to store supplementary data and/or software modules used by the control system 800. The storage device 807 can include a hard drive, an optical drive, a thumb-drive, an array of drives, or any combinations thereof. Further, the storage device 807 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 803), perform one or more methods, such as those described above.

The control system 800 can be linked through the bus 809, optionally, to a display interface or user Interface (HMI) 847 adapted to connect the system 800 to a display device 849 and a keyboard 851, wherein the display device 849 can include a computer monitor, camera, television, projector, or mobile device, among others. In some implementations, the system 800 may include a printer interface to connect to a printing device, wherein the printing device can include a liquid inkjet printer, solid ink printer, large-scale commercial printer, thermal printer, UV printer, or dye-sublimation printer, among others.

The high-speed interface 811 manages bandwidth-intensive operations for the control system 800, while the low-speed interface 813 manages lower bandwidth-intensive operations. Such allocation of functions is an example only. In some implementations, the high-speed interface 811 can be coupled to the memory 805, the user interface (HMI) 845, and to the keyboard 851 and the display 849 (e.g., through a graphics processor or accelerator), and to the high-speed expansion ports 815, which may accept various expansion cards via the bus 809. In an implementation, the low-speed interface 813 is coupled to the storage device 807 and the low-speed expansion ports 817, via the bus 809. The low-speed expansion ports 817, which may include various communication ports (e.g., USB, Bluetooth, Ethernet, wireless Ethernet) may be coupled to the one or more input/output devices 841. The control system 800 may be connected to a server 853 and a rack server 855. The control system 800 may be implemented in several different forms. For example, the control system 800 may be implemented as part of the rack server 855.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A controller for controlling a motor, the controller comprising: a processor; and a memory having instructions stored thereon that, when executed by the processor, cause the controller to:
collect a feedback signal indicative of a current state of an operation of the motor;
determine current constraints on parameters of the operation of the motor using a model of dynamics of the motor connecting the current state of the motor with the current constraints on the operation;
determine a control trajectory of the operation of the motor based on the current constraints on parameters of the operation of the motor using a parametrized estimation agnostic to the dynamics of the motor; and
control the motor according to the control trajectory.

2. The controller of claim 1, wherein the controller controls the motor over a sequence of control steps including a first control step having a first value of the current constraints and a second control step having a second value of the current constraints different from the first value of the current constraints, such that the reference trajectory is updated between the first and the second control step.

3. The controller of claim 1, wherein the memory stores executable instructions forming modules of the controller executed by the processor for controlling the motor, the modules comprising:
a motion planner configured to generate a parameterized reference trajectory using predetermined constraints on the operation of the motor;
constraint estimator configured to estimate the current constraints on parameters of the operation of the motor; and
a motion reshaper configured to reshape the parameterized reference trajectory based on the current constraints to generate the control trajectory.

4. The controller of claim 3, wherein the motion reshaper is implemented as a reference governor accepting dynamically varying constraints on the operation of the motor.

5. The controller of claim 4, wherein the motion reshaper is configured to:
determine reference points at each time step of the parameterized reference trajectory, wherein each reference point of the reference points includes a desired velocity at a corresponding time step and a desired acceleration at a next time step;
reshape each desired acceleration and a corresponding desired velocity, based on the dynamically varying constraints on the operation of the motor to generate reshaped feasible reference acceleration and reshaped feasible reference velocity for the motor corresponding to each desired acceleration and the corresponding desired velocity; and
generate the control trajectory, based on the reshaped feasible reference acceleration and reshaped feasible reference velocity generated for each reference point of the parameterized reference trajectory.

6. The controller of claim 5, wherein the motion planner is further configured to generate the parameterized reference trajectory, based on a target state of operation of the motor, wherein to generate the control trajectory, the motion reshaper is further configured to:
generate a reshaped reference trajectory, based on the reshaped feasible reference acceleration and reshaped feasible reference velocity generated for each reference point of the parameterized reference trajectory; and
adjust the reshaped reference trajectory, based on the target state to produce the control trajectory.

7. The controller of claim 5, wherein to reshape each desired acceleration and a corresponding desired velocity, the motion reshaper is configured to formulate and solve an optimization problem subject to the dynamically varying constraints on the operation of the motor.

8. The controller of claim 5, wherein to reshape each desired acceleration and a corresponding desired velocity, the motion reshaper is configured to:
formulate a velocity optimization problem with velocity at the next time step being a decision variable; and
execute a sequential search over a finite set of solution candidates, subject to the velocity optimization problem.

9. The controller of claim 4, wherein the motion reshaper is configured to:
determine a next point corresponding to a reference point at current time step on the parameterized reference trajectory, wherein the next point includes a desired velocity at the current time step and a desired acceleration at a next time step subsequent to the current time step;
reshape the desired acceleration and the corresponding desired velocity, based on the dynamically varying constraints on the operation of the motor to generate reshaped feasible reference acceleration and reshaped feasible reference velocity for the motor; and
generate the control trajectory, based on the reshaped feasible reference acceleration and reshaped feasible reference velocity.

10. The controller of claim 9, wherein the motion planner is further configured to generate the parameterized reference trajectory, based on a target state of operation of the motor, wherein to generate the control trajectory, the motion reshaper is further configured to:
generate a reshaped reference trajectory, based on the reshaped feasible reference acceleration and the reshaped feasible reference velocity for the motor; and
adjust the reshaped reference trajectory, based on the target state to produce the control trajectory.

11. The controller of claim 3, wherein the constraint estimator is configured to
extract a current state of the motor from the feedback signal; and
estimate the current constraints including current torque bounds of the motor defining maximum and minimum torque given the state of the operation of the motor.

12. The controller of claim 11, wherein the motion reshaper adjusts the parameterized reference trajectory based on the current torque bounds.

13. The controller of claim 11, wherein the constraint estimator is configured to determine, the current constraints based on an analytical mapping from parameters of a model of dynamics of the motor to the maximum and minimum torque, given the current state of the operation of the motor.

14. The controller of claim 13, wherein the modules further include a dynamics estimator configured to estimate the parameters of the model of dynamics of the motor from a sequence of measurements of the state of the motor.

15. The controller of claim 1, wherein the processor is configured to update the parameters of the model of dynamics of the motor by decreasing an error between a predicted state of operation of the motor and the current state.

16. The controller of claim 3, wherein the predetermined constraints are acquired by a restriction on kinematic variables of the state of the motor.

17. A computer implemented method for controlling a motor, comprising:
collecting a feedback signal indicative of the current state of an operation of the motor;
determining current constraints on parameters of the operation of the motor using a model of dynamics of the motor connecting the current state of the motor with the current constraints on the operation;
determining a reference trajectory of the operation of the motor based on the current constraints on parameters of the operation of the motor using a parametrized estimation agnostic to the dynamics of the motor; and
controlling the operation of the motor according to the control trajectory.

18. The method of claim 17, further comprising controlling the motor over a sequence of control steps including a first control step having a first value of the current constraints and a second control step having a second value of the current constraints different from the first value of the current constraints, such that the reference trajectory is updated between the first and the second control step.

19. The method of claim 17, further comprising:
generating a parameterized reference trajectory using predetermined constraints on the operation of the motor;
estimating the current constraints on parameters of the operation of the motor; and
reshaping the parameterized reference trajectory based on the current constraints to generate the control trajectory.

20. The method of claim 19, wherein reshaping the parameterized reference trajectory is executed using a reference governor accepting dynamically varying constraints on the operation of the motor.
